(19) United States
(12) Patent Application Publication
(10) Pub. No.: US 2002/0065835 A1
(43) Pub. Date: May 30, 2002

(54) File system assigning a specific attribute to a file, a file management method assigning a specific attribute to a file, and a storage medium on which is recorded a program for managing files

(76) Inventor: Naoya Fujisaki, Kawasaki (JP)

Correspondence Address: STAAS & HALSEY LLP, 700 11TH STREET, NW, SUITE 500, WASHINGTON, DC, 20001, US

(21) Appl. No.: 09/819,701

(22) Filed: Mar. 29, 2001

(30) Foreign Application Priority Data
Nov. 27, 2000 (JP) 2000-358750

(51) Int. Cl. G06F 12/00

(52) U.S. Cl. 707/200

(57) ABSTRACT

In a file system configured by one or a plurality of volumes, policy attribute data is set in correspondence with the path information of a directory, and a file is managed based on the policy attribute data. As a result, a policy specific to the directory can be set while maintaining the compatibility with an existing file system. For example, a volume number is set as the policy attribute data of a file, so that a file system administrator can specify the storage location of the file.

### BACKGROUND OF THE INVENTION

1. Field of the Invention

The present invention relates to a file system configured by one or a plurality of volumes, a file management method thereof, and a storage medium on which is recorded a program for managing files.

2. Description of Related Art

With the recent popularization of computer systems, computers have been utilized in all of fields. Especially, in a computer system in an organization such as a company, etc., a server that centralizes and manages information is arranged to share the information efficiently.

Furthermore, as the Internet and intranets become popular, individual information obtained by downloading e-mail or Web files has been unexpectedly increasing in addition to pre-estimated information that an organization itself collects and generates. As a result, it is unavoidable to add disk devices for storing information to a server one after another.

If a wide variety of information is stored by a server in a disk device group in a confused fashion, it is difficult to grasp what information is lost when a fault occurs in a disk device.

To overcome the problems posed when such a large amount of information is managed, a policy for distributing information to disk devices depending on the type of information is introduced.

For such a policy introduction, system performance must be prevented from being degraded due to an overhead of the policy process. Furthermore, the compatibility between information managed with a policy (a file attribute according to a policy) and general information (a file attribute) must be considered.

As the policy implemented by a conventional file system, a UNIX quota exists. The UNIX quota implements the policy for restricting the disk capacity used by each user.

If the disk capacity a user is allowed to use is exceeded, an application combined with this quota notifies the user of this phenomenon or an instruction from an administrator via e-mail. However, no other policy but the UNIX quota exists as the policy implemented by a conventional file system.

By way of example, the UNIX quota implements the policy for restricting the disk capacity used by each user. Although there may be cases where the disk capacity used is desired to be restricted not for each user but for each group, such a policy cannot be implemented with the conventional file system.

Furthermore, current file systems normally adopt a multi-volume configuration comprising a plurality of disks (volumes) due to an increase in the amount of information.

When such a multi-volume configuration is adopted, a file system administrator sometimes desires to store a certain file on a certain disk, for example, to store a file having a high access frequency onto a disk the access speed of which is fast.

With the conventional system, however, which file is stored on which disk is determined by the file system itself, and an administrator of the file system cannot be involved in this determination. Accordingly, a policy that meets the above described demand cannot be realized.

Furthermore, if such a multi-volume configuration is adopted, a file system administrator sometimes desires to transfer a file having a high access frequency to another disk the access speed of which is fast as a result of measuring the access frequency of the file.

However, the conventional file system provides the technique for measuring not the access frequency of a file or a file group, but that of the entire file system. Therefore, the policy satisfying such a demand cannot be realized.

As described above, the only policy provided by the conventional file system is the UNIX quota, which is very much insufficient.

Additionally, it is necessary to prevent the overhead of a policy process from increasing when the policy is implemented.

With the policy implemented by the UNIX quota, if the disk capacity a user is allowed to use is exceeded, this is notified to the user via e-mail. However, since a period of time is required from the reception of e-mail by the user till the deletion of an unnecessary file when viewed from a file system administrator, the overhead of the policy process increases.

Furthermore, to implement a policy, attribute data used for the policy implementation must be prevented from being lost during a backup process performed by the file system.

With the policy implemented by the UNIX quota, an archive file backs up only file data when a file managed with a policy (a file managing attribute data for implementing a policy) is backed up in the archive file. Accordingly, the attribute data for implementing the policy is lost.

Furthermore, compatibility with a different file system must be provided to implement a policy.

### SUMMARY OF THE INVENTION

It is an object of the present invention to implement a file system that can set policy attribute data specific to a directory while maintaining the compatibility with a normal file system. It is another object of the present invention to reduce an overhead of a policy process. It is a further object of the present invention not to lose policy attribute data when a file is backed up.

In a first aspect of the present invention, a file system, which is configured by one or a plurality of volumes, comprises a setting unit setting policy attribute data in correspondence with path information of a directory, and a file managing unit managing a file based on the path information of the directory and the policy attribute data. A volume is, for example, one unit of a storage medium, magnetic storage medium, a disk device, etc..

According to the first aspect of the present invention, a file or a file group can be managed based on policy attribute data by setting the policy attribute data for implementing a policy capability in correspondence with the path information of a directory.

For example, a volume number is set as the policy attribute data of a file, so that a file system administrator can specify the storage location of the file. As a result, a file access time can be shortened by storing a file having a high access frequency onto a disk the access speed of which is fast.

Additionally, a restriction condition of a disk capacity is set as the polity attribute data of a directory, thereby restricting the disk capacity occupied by a file within the directory.

Furthermore, the policy attribute data may include the information indicating whether or not a path search is required.

This configuration eliminates the need for making a path search for all of directories, thereby increasing the efficiency of the path search process.

Still further, a control table to which the information indicating a point at which the path search is made next is registered may be arranged, and pointer information pointing to the information indicating the point at which the path search is made next, which is registered to the control table, may be registered as the information indicating whether or not to require the path search for the policy attribute data.

With this configuration, whether or not to require the path search can be determined by checking if the information indicating the directory for which the path search is to be made next is registered to the corresponding position within the control table, which is specified by the pointer information of the policy data for the directory.

This eliminates the need for making an unnecessary path search, thereby increasing the efficiency of the path search process.

Still further, if a file operation violates policy attribute data when being performed, registration such that the operation violates the policy attribute may be made.

With this configuration, the overhead of the policy process can be reduced, and a policy violation can be resolved when the processing capability of the system can afford to perform more operations.

Still further, a policy violated by a file or a directory may be recovered and optimized.

Still further, policy data (path information of a directory and policy attribute data) may be stored as a hidden file in an archive file when a file is stored in the archive file, and the policy data stored in the hidden file may be read and registered when the file data stored in the archive file is restored.

In a second aspect of the present invention, a file system configured by one or a plurality of volumes comprises a setting unit setting policy attribute data in correspondence with the path information of a directory, and an assigning unit making a subdirectory inherit the policy attribute data of the directory, or assigning the policy attribute data of the subdirectory.

According the second aspect of the present invention, policy attribute data set in a parent directory can be inherited to its subdirectory, or also the policy attribute data of the subdirectory can be inherited to a directory at a move destination, if the name of the directory is changed.

Additionally, if policy attribute data is not specified for a subdirectory when the name of a directory is changed, the policy attribute data of the parent directory may be inherited to the subdirectory. Or, if policy attribute data is specified for the subdirectory, the specified policy attribute may be assigned to the subdirectory.

Furthermore, whether or not policy attribute data must be inherited may be predefined. If policy attribute data of a parent directory is data that is requested to be inherited, the policy attribute data may be inherited to a subdirectory. Or, if the policy attribute data is data that is not requested to be inherited, specified policy attribute data may be assigned to the subdirectory.

Still further, policy attribute data may be configured by a capability code specifying a policy capability.

With this configuration, for the policy capability specified by a certain capability code, the policy attribute data of a parent directory can be inherited to a subdirectory. For the policy capability specified by another capability code, the policy attribute data of not a parent directory but a subdirectory can be inherited to a target directory (such as a directory at a move destination).

### BRIEF DESCRIPTION OF THE DRAWINGS

FIG. 1 explains policy data;

FIG. 2 explains policy specification;

FIG. 3 explains the capabilities of a file system, and a policy control module;

FIG. 4 explains a backup/restore process for policy data;

FIG. 5 explains the backup/restore process for policy data;

FIG. 6 explains a search process;

FIG. 7 explains the search process;

FIG. 8 explains a path search table;

FIG. 9 is a flowchart explaining the search process;

FIG. 10 explains attribute data;

FIG. 11 explains the process for managing the value of the total size of files;

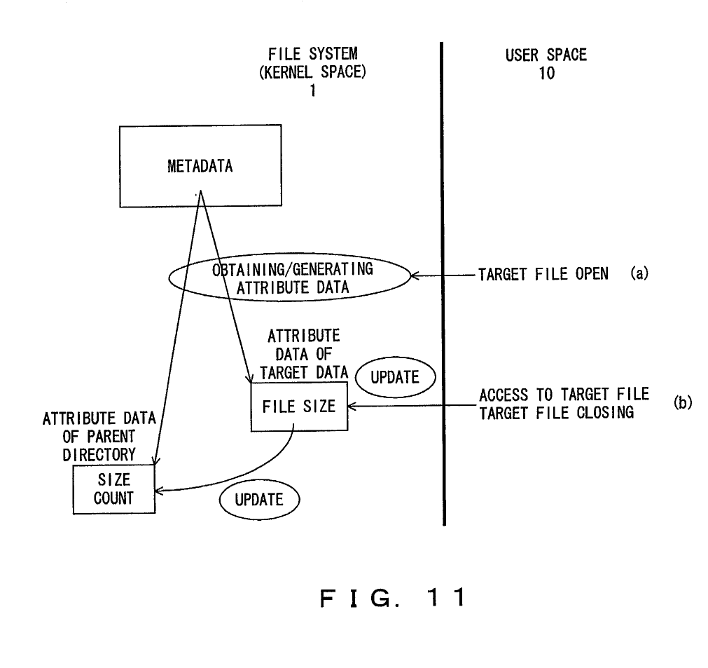

FIG. 12 explains a policy violation process;

FIG. 13 explains the policy violation process; and

FIG. 14 explains a policy violation recovery process.

### DESCRIPTION OF THE PREFERRED EMBODIMENTS

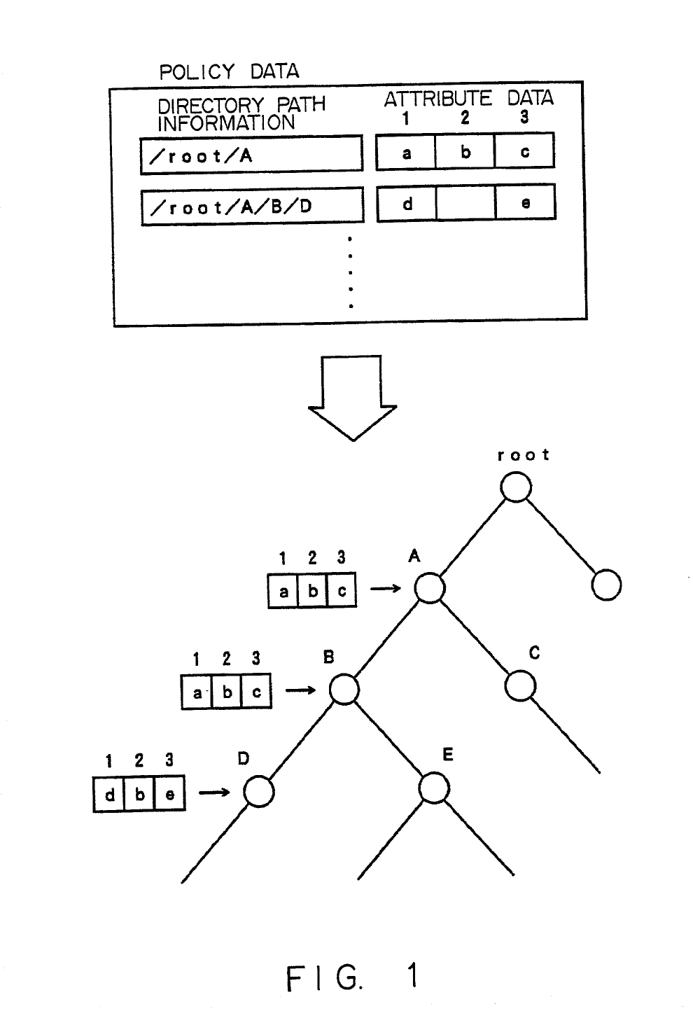

Hereinafter, preferred embodiments according to the present invention will be described. First of all, the fundamental configuration is explained. FIG. 1 shows the policy data and the file structure of directories in a file system according to the present invention.

The file system according to a preferred embodiment is configured by one or a plurality of disks, and includes attribute data (policy attribute data) specifying a policy capability is set in correspondence with the path information of a directory.

Assume that the first and the third attribute data do not have an inheritance characteristic, and the second attribute data has the inheritance characteristic, when policy data possessing the three attribute data is input.

In this case, if the following policy data

(/root/A):(a, b, c)

(/root/A/B/D):(d, no specification, e)

is input, attribute data (a, b, c) is assigned to a directory A, the attribute data (a, b, c) is assigned to a directory B, and attribute data (d, b, e) is assigned to a directory D.

Since the file system according to this preferred embodiment has such an attribute assignment capability, a file system administrator can store a file onto his or her desired disk according to the specification of a directory in which the file is to be stored, by defining a volume number as one piece of attribute data possessed by the policy data.

Additionally, for example, quota is defined as one piece of the attribute data possessed by the policy data, so that a file system administrator can restrict the used disk capacity for a certain directory. As a result, the used disk capacity can be restricted for each group (depending on a group).

Furthermore, for example, an instruction to gather statistical information is defined as one piece of the attribute data possessed by the policy data, so that a file system administrator can gather the statistical information of a file or a file group by targeting the file or the file group within a certain directory.

In this way, with the file system according to this preferred embodiment, attribute data specific to a file can be assigned in correspondence with the path information of a directory, thereby adding various values. At this time, an inheritance method is varied depending on the capability of attribute data, whereby consistency of an individual policy capability can be maintained.

In this configuration, an assigning unit may assign the information of the total size of files within a directory to the directory including the files as one piece of attribute data.

With this capability, the total data size of files that move from one disk to another, for example, by a rename system call can be obtained by searching only the corresponding directory, thereby eliminating the overhead of accesses to metadata of the files.

A storing unit generates a hidden file when file data is stored in an archive file, stores input policy data as the hidden file (stab-file) in the archive file.

Since the archive file backs up only file data, input policy data is lost at the time of backup if the storing unit is not prepared. Therefore, an interface, namely, the storing unit backing up policy data is arranged.

By preparing the backup interface capability, policy data specific to a file system is extracted and backed up in an archive file as one piece of file data in the form of a hidden file, whereby policy data dependent on the file system can be held without changing the specifications of the data format of a conventional archive file.

Additionally, a registering unit reads and registers the policy data stored in the hidden file when the file data stored in the archive file is again stored.

Even if policy data specific to a file system is merely backed up in an archive file with the above described process of the storing unit, the policy data in the original file itself at a backup source is lost although the policy data exists as a hidden file. Therefore, an interface, namely, the registering unit restoring the policy data is arranged.

By preparing the restore interface capability, policy data stored as a hidden file in an archive file is extracted, and registered and set in a file system. Consequently, a file possessing policy data dependent on one file system can be restored in another file system without changing the specifications of the data format of a conventional archive file.

Furthermore, the registering unit, which is arranged in correspondence with a parent directory specified by a request to make a directory, registers pointer information to a control table managing the information indicating up to where the directory path information possessed by policy data is searched. If there is no need to search the directory path information, the registering unit does not register its pointer information, so that whether or not the directory path information possessed by the policy data must be searched is displayed. If the directory path information must be searched, from where the directory path information must be searched is displayed.

When the file data stored in an archive file is again stored in a file system, attribute data possessed by policy data must be assigned to the directory for which the policy data is specified.

By preparing the recording unit at this time, an unnecessary path search can be prevented from being performed, and a duplicate search in an already searched path portion can be also prevented, leading to a significant reduction in the overhead of the path search process.

When this configuration is adopted, a second registering unit registers an occurrence of a policy data violation state to the corresponding attribute data possessed by policy data, if the policy data violation state occurs at the time of a file operation.

For example, if the volume specified by policy data has no empty space in one file system when a volume is assignment, it is desirable not to cause an access error by assigning another volume having an empty space.

By preparing the second registering unit at this time, a file that does not comply with policy data can be registered as a policy violation. Consequently, the overhead of the policy implementation process can be eliminated, and at the same time, a write error can be prevented from occurring, whereby the specifications of a general-purpose UNIX file system can be conformed regardless of whether or not a policy exists.

For the policy implemented by the UNIX quota, the overhead of the policy process is large. This is because if the restricted capacity a user is allowed to use is exceeded, this is notified to the user via e-mail.

In the meantime, according to this preferred embodiment, the mechanism for registering an occurrence of a policy violation is provided by preparing the second registering unit, so that a temporary use even after the restricted capacity is exceeded can be implemented. As a result, the overhead of the policy process can be reduced.

Furthermore, the recovering unit performs a policy recovery process for a file or directory that violates a policy while optimizing the file or directory.

Assume that a policy is likely to be recovered because of the appearance of an empty space in an original target volume or the addition of a new volume to the original policy, after a volume different from that specified by the policy is assigned in the case where the original volume has no empty space. In this case, it is desirable to move data from the current volume to the volume complying with such a policy, and to optimize the location of the data from a data management viewpoint.

By preparing the recovering unit at this time, it becomes possible to immediately search for a file or directory the policy of which is to be recovered from a policy violation list to which the file or directory is registered, and to recover and optimize the policy if it can be recovered by judging from the state of the system such as the existence of an empty space of a volume.

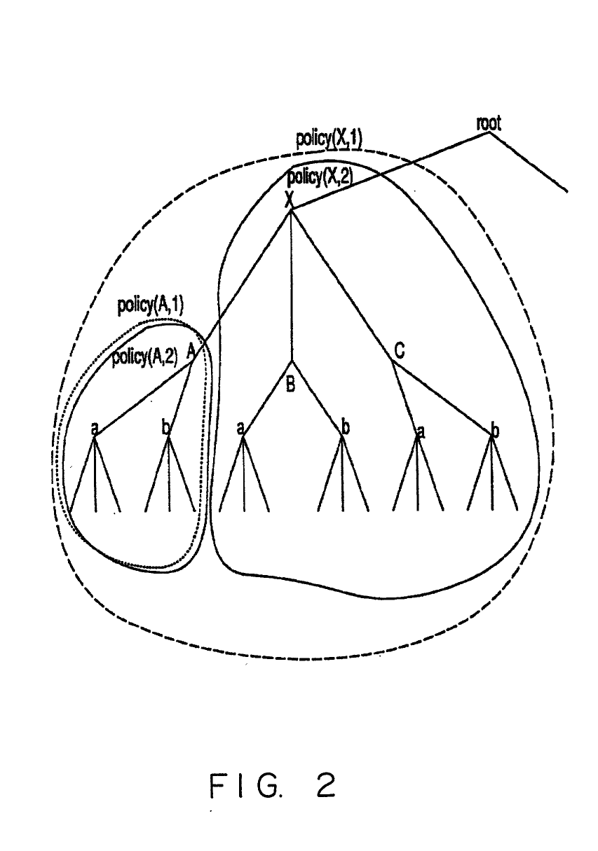

FIG. 2 shows an example of the policy specification implemented by the file system according to this preferred embodiment (one or a plurality of file systems may be used depending on a case).

With the file system according to this preferred embodiment, a policy is specified for a directory in a way such that a subdirectory is made to inherit a policy in principle if the policy is specified for its parent directory, and a policy specified for a subdirectory overrides a policy that is not requested to be inherited. For example, if a policy (X,1) is specified for a directory X, this policy is inherited to the directory partitioned by the policy (X,1) shown in FIG. 2. If a policy (X,2) is specified for the directory X, this policy is inherited to the directory partitioned by the policy (X,2). If a policy (A,1) is specified for a directory A, this policy is inherited to the directory partitioned by the policy (A,1) shown in FIG. 2. If a policy (A,2) is specified for the directory A, this policy is inherited to the directory partitioned by the policy (A,2).

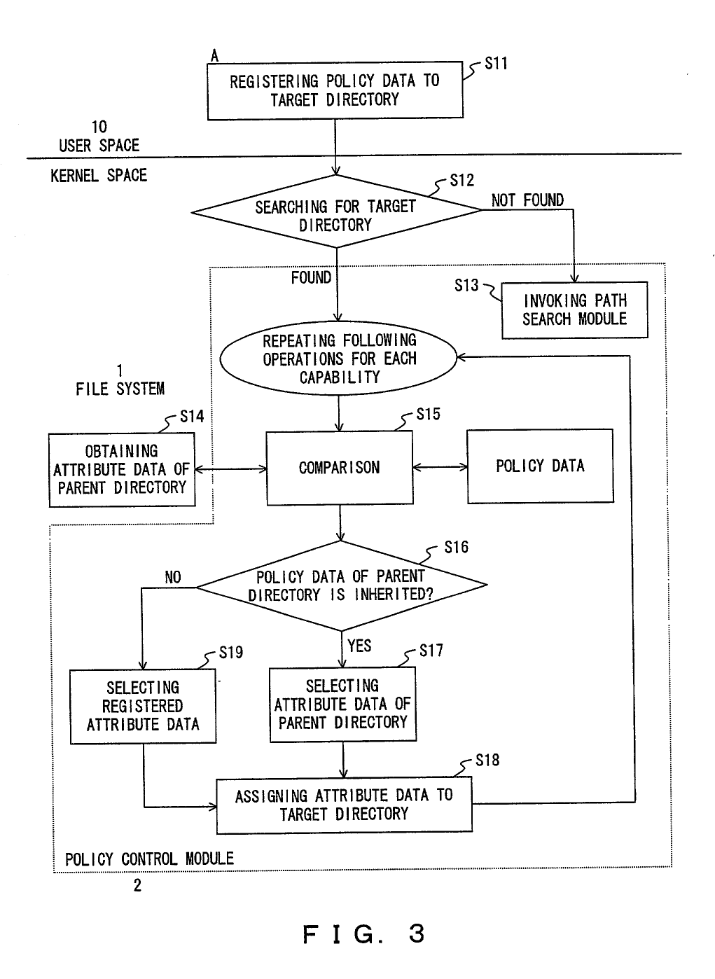

FIG. 3 exemplifies the file system performing such a policy specification process according to the preferred embodiment.

In this figure, 1 indicates a file system, 2, indicates a policy control module comprised by the file system 1, a path search module comprised by the file system 1, and 10 indicates a user space.

Here, a program implementing the policy control module 2 or the path search module 3 can be stored onto a suitable computer-readable storage medium such as a semiconductor memory, a CD-ROM, etc.

When a policy specification process is performed, an administrator of the file system 1 registers policy data to be processed as indicated by “A” shown in FIG. 3 (S11 of FIG. 3). The policy data registered at this time is structured by the path information of a directory (target directory) and one or a plurality of pieces of attribute data (policy attribute data) specified in correspondence with the path information as shown in FIG. 1.

When the policy data is registered, the file system 1 searches for the target directory (S12). If the target directory is not found, the file system 1 invokes the path search module 3 (S13). If the target directory is found, the file system 1 invokes the policy control module 2.

Once invoked in this way, the policy control module 2 repeats the following operations for each attribute data (capability data) possessed by policy data.

Namely, first of all, attribute data to be processed, which is possessed by a parent directory, is obtained from metadata (information for managing data such as the attribute, contents, storage location, etc. of data) (S14). The attribute data to be processed (policy attribute data), which is possessed by the registered policy data, is compared with the obtained data (step S15). Then, it is determined whether or not the attribute data of the parent directory is inherited according to the inheritance attribute defined for each attribute data (S16). If it is determined that the attribute data of the parent directory is inherited, this data is assigned to the target directory (S17 and S18). If it is determined that the attribute data of the parent directory is not inherited, specified attribute data is assigned to the target directory (Sl9 and S18).

As described above, with the file system 1, a policy is specified for a directory in a way such that a policy is inherited to a subdirectory in principle if the policy is specified for its parent directory, and a policy specified for a subdirectory overrides a policy that is not requested to be inherited.

With this file system 1 to which such an attribute data assignment capability is provided, for example, a volume number is defined as one piece of attribute data possessed by policy data, so that an administrator of the file system 1 can store a file onto his or her desired disk according to the specification of a directory in which the file is to be stored.

Additionally, for example, quota is defined as one piece of the attribute data possessed by the policy data, so that the administrator of the file system 1 can restrict the used disk capacity for the files within a directory, whereby the used disk capacity can be restricted for each path name.

Furthermore, for instance, an instruction to gather statistical information is defined as one piece of the attribute data possessed by the policy data, so that the administrator of the file system 1 can gather the statistical information of a file or a file group by targeting the file or the file group within a directory.

Also in the file system 1 according to the present invention, file data must be backed up in an archive file in a similar manner as in a file system that does not comprise the present invention.

Since the archive file backs up only file data, policy data assigned to a directory can be possibly lost at the time of backup according to the conventional technique.

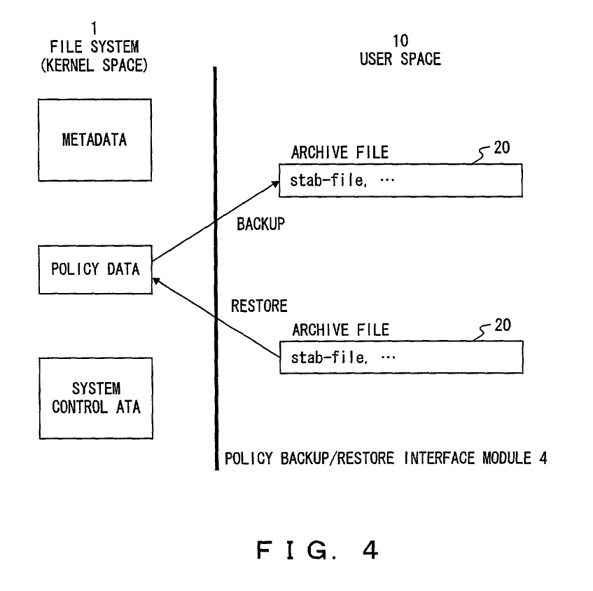

Therefore, the file system 1 according to this preferred embodiment adopts a policy backup/restore interface module 4 that performs a process for generating a hidden file (stab-file shown in FIG. 4) when file data is backed up in an archive file 20, for storing policy data in the hidden file, for backing up the policy data in the archive file 20, and for restoring also the policy data backed up in the hidden file when restoring the file data backed up in the archive file 20, as shown in FIG. 4.

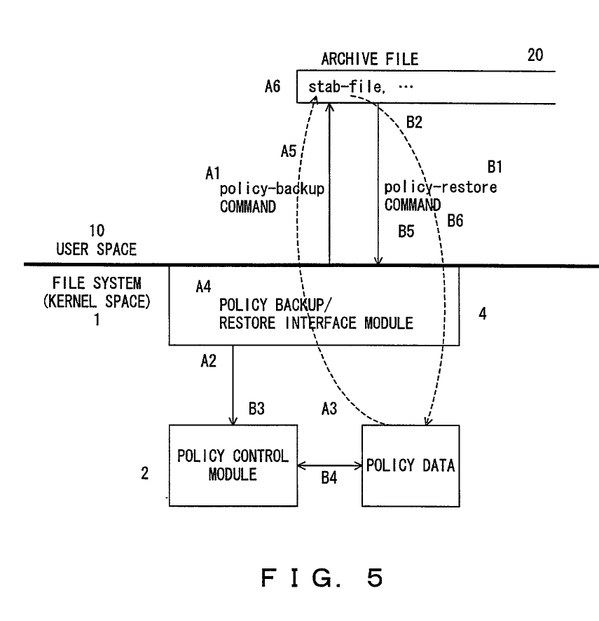

Next, the process performed by the policy backup/restore interface module 4 will be explained in detail with reference to FIG. 5.

An administrator of the file system 1 issues a backup command for policy data so as to back up file data in the archive file 20 (A1 shown in FIG. 5).

Upon receipt of the backup command, the policy backup/restore interface module 4 passes this command to the policy control module 2 (A2 shown in FIG. 5). Upon receipt of this command, the policy control module 2 extracts policy data that the module itself manages, and passes the extracted policy data to the policy backup/restore interface module 4 (A3 shown in FIG. 5).

Upon receipt of this policy data, the policy backup/restore interface module 4 passes the received policy data to the issued backup command (A4 shown in FIG. 5). Upon receipt of the policy data, the issued backup command generates a hidden file (stab-file shown in this figure), and stores the received policy data in the hidden file (A5 shown in FIG. 5).

Lastly, the issued backup command stores the backup of the file data along with a hidden file in the archive file 20 (A6 shown in FIG. 5). Here, the process is terminated.

Furthermore, the administrator of the file system 1 issues a restore command for the policy data when restoring the file data backed up in the archive file 20 (B1 shown in FIG. 5).

The issued restore command extracts the policy data from the hidden file (stab-file shown in FIG. 5) stored within the archive file 20, and passes the extracted policy data to the policy backup/restore interface module 4 (B2 shown in FIG. 5).

Upon receipt of this policy data, the policy backup/restore interface module 4 passes the issued restore command and the received policy data to the policy control module 2 (B3 shown in FIG. 5). Then, the policy control module 2 registers and manages the received policy data according to the issued restore command, and returns to the policy backup/restore interface module 4 a notification that the policy data is registered and managed (B4 shown in FIG. 5).

Upon receipt of this notification, the policy backup/restore interface module 4 passes to the issued restore command a notification that the policy data has been restored (B5 shown in FIG. 5). Upon receipt of this notification, the issued restore command restores the data of the archive file 20 excluding the hidden file in the file system 1 according to the present invention (B6 shown in FIG. 5). Here, the process is terminated.

As described above, with the file system 1, the policy backup/restore interface module 4 is prepared, so that policy data specific to a file system is extracted, and backed up in the archive file 20 in the form of a hidden file as one piece of file data. As a result, the policy data dependent on the file system can be held without changing the specifications of the data format of a conventional archive file.

Additionally, the policy data stored in the hidden file within the archive file 20 is extracted, and the extracted policy data is registered and set in the file system, whereby a file having policy data dependent on one file system can be restored in another file system without changing the specifications of the data format of a conventional archive file.

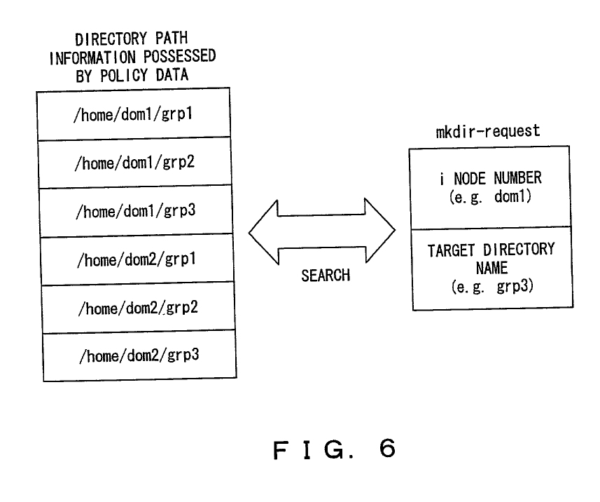

To restore the file data backed up in the archive file 20, a make-directory-request (mkdir-request) command is issued (FIG. 6). The file system 1 generates a directory in response to the make-directory-request command similar to a file system that does not comprise the present invention, and restores the file data in the generated directory if a file-create command is issued subsequently to the make-directory-request command.

In addition to this process, the file system 1 must restore the attribute data possessed by policy data in a counterpart directory. Therefore, when the make-directory-request command is issued, a search is made to determine whether or not the directory path specified by this command matches the directory path information (information restored from the hidden file) possessed by the policy data. If both of them match, the attribute data possessed by the policy data, which is transmitted next, must be restored in the directory generated by the make-directory-request command.

If the make-director-request command is issued, the name of the target directory (the name of the directory to be generated), and the i node number of the current directory (the parent directory of the target directory) are passed to the file system 1, similar to a file system that does not comprise the present invention.

Then, in this search process, it must be determined whether or not the data pairing the current directory and the name of the target directory matches the directory path information possessed by the policy data, which is a time-consuming operation.

Accordingly, a path search table 5 for managing a checkpoint indicating up to where the directory path information possessed by the policy data has been searched (inversely speaking, the information indicating the starting point of the path search process) is arranged, and a check index pointing to a checkpoint to be referenced in the path search table 5 is registered to the metadata specified by the i node number of the current directory specified with the make-directory-request command. If there is no need to make a search, no check index is registered.

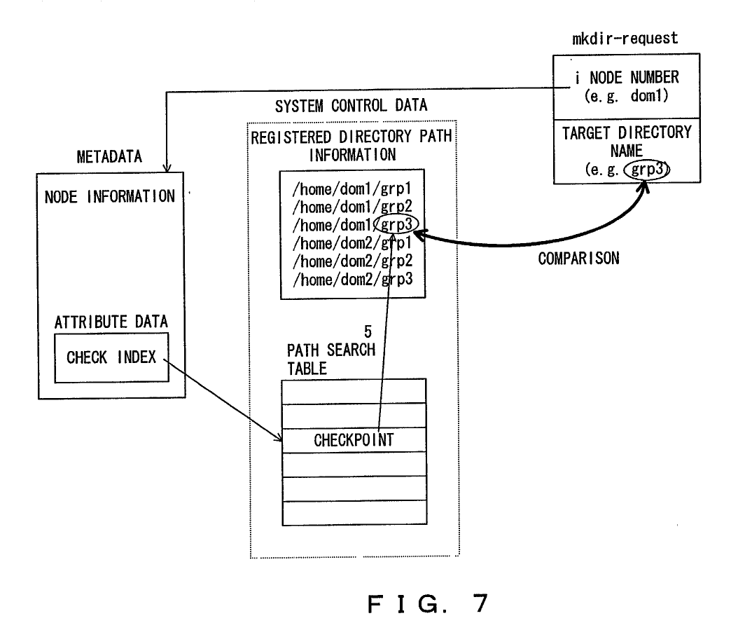

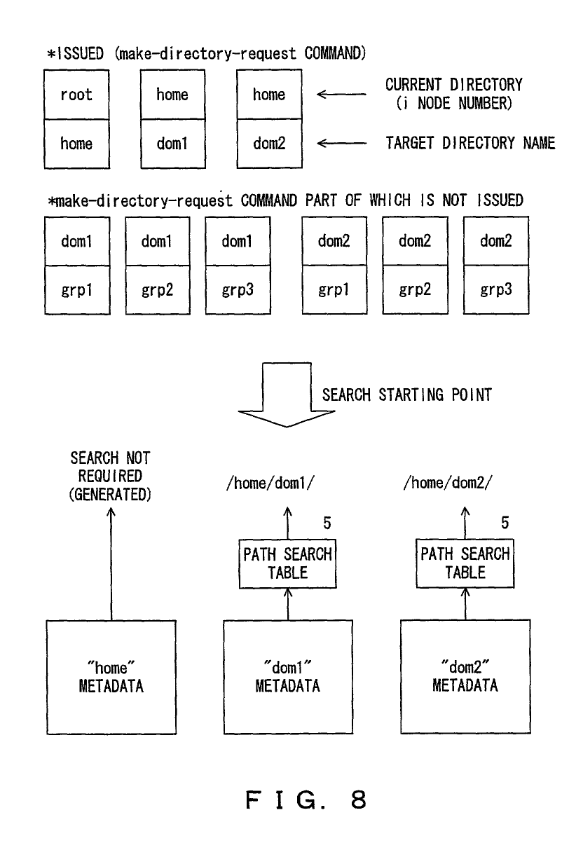

If explanation is provided with reference to an example shown in FIG. 7, two subdirectories “dom1” and “dom2” are registered within a directory “home”. If the two subdirectories have been searched (that is, the two subdirectories have been generated), there is no need to search the directory path information possessed by the policy data even if the make-directory-request command is issued for the “home” as the current directory after that. Therefore, as shown in FIG. 8, a registration such that the search process is not required because of the absence of check index registration is made to the metadata managing the attribute of the “home”.

As is known from this example, it can be immediately determined whether or not a search must be made by checking if a check index is registered, whereby an unnecessary path search can be prevented from being performed.

Furthermore, three subdirectories “grp1”, “grp2”, and “grp3” are registered within the “dom1”. If all of these subdirectories have not been searched yet (namely, all of the subdirectories have not been generated), a registration such that the search process must be performed is made by registering the check index instructing the reference of a checkpoint indicating that the search has been terminated up to the “dom1”, to the metadata managing the attribute of the “dom1”, as shown in FIG. 8.

At this time, it is determined whether or not the the target directory name specified by the make-directory-request command is registered to the directory path information possessed by the policy data by comparing the target directory name with the next directory indicated by the checkpoint.

As is known from the above provided description, a duplicate search in the already searched portion (already generated path portion) can be prevented according to the checkpoint indicated by the check index, thereby significantly reducing the overhead of the path search process.

For example, if only one check index is registered to the metadata managing the attribute of the “dom1”, and if the checkpoint indicated by the check index points to, by way of example, “dom1/grp1”, “grap2” or “grap3” is sometimes specified as the target directory name. Therefore, if the “grp1” is specified as the target directory name, it is determined whether or not the target directory name is registered to the directory path information possessed by the policy data while searching for the entry pointed to by the checkpoint upward and downward.

Additionally, for instance, when the search in the “home” is terminated, the check index registered to the metadata managing the attribute of the “home” is re-registered to the metadata managing the attributes of the subdirectories “dom1” and “dom2”. As a result, the checkpoint indicating up to where the search has been terminated is succeeded.

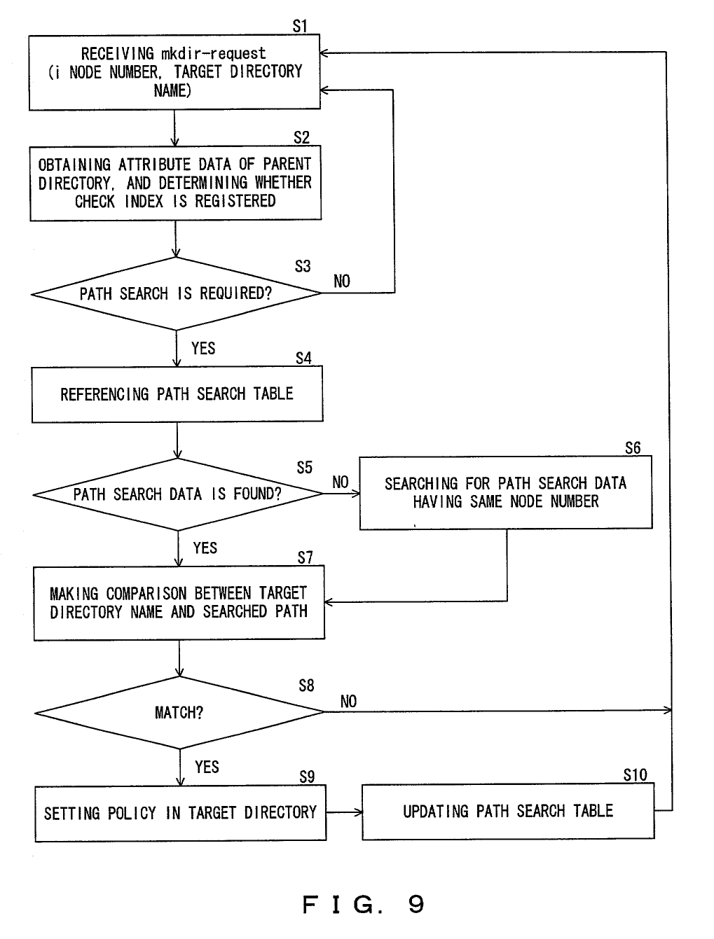

Next, the process performed when the make-directory-request command is issued is explained in detail according to the process flow shown in FIG. 9.

When the make-directory-request command is issued, the file system 1 first receives this command in step S1 as represented by the process flow shown in FIG. 9.

Next, the target directory name specified by the make-directory-request command and the node number of its parent directory are obtained in step S2. Then, the attribute data (i node number) of the parent directory is obtained from the metadata based on the node number. It is then determined from the obtained attribute data whether or not a check index is registered. If the check index is registered, the checkpoint indicated by the check index is obtained.

Next, in step S3, it is determined whether or not to require the path search depending on whether or not a check index is registered. If it is determined not to require the path search because no check index is registered, it is determined that the policy data is not specified for the path specified by the issued make-directory-request command. The process then goes back to step S1 so as to wait for the next make-directory-request command.

If it is determined to require the path search because the check index is registered, the process goes to step S4 where the checkpoint in the path search table 5, which is indicated by the check index, is referenced. In step S5, it is determined whether or not the target path search data exists according to the referenced checkpoint. If it is determined that the target path search data does not exist, the process goes to step S6 where path search data having the same node number is searched. Then, the process goes to step S7 to be described next.

If it is determined that the target path search data exists in step S5, the process goes to step S7 where the path name specified by the policy is extracted from the path check starting point within the data, and the extracted path name is compared with the target directory name specified by the make-directory-request command.

If the target directory name mismatches the path name specified by the policy as a result of the comparison in step S8, it is determined that no policy data is specified for the path specified by the issued make-directory-path command. The process then goes back to step S1 so as to wait for the next make-directory-request command.

If the target directory name matches the path name specified by the policy, the process goes to step S9 where the policy is set in the attribute data of the target directory. After the path check starting point for the target path search data is updated (checkpoint is advanced) in step S10, the process goes back to step S1.

As described above, with the file system 1, it can be quickly determined whether or not the directory path specified by the make-directory-request command matches the directory path information possessed by policy data.

As described above, with the file system 1 according to this preferred embodiment, quota is defined as one piece of attribute data possessed by policy data, whereby an administrator of the file system 1 can restrict the disk capacity used for files within a directory.

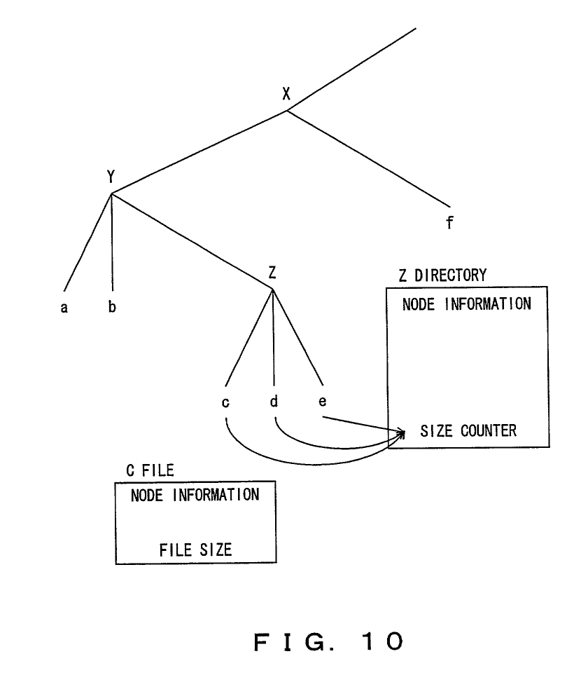

When the process for restricting the disk capacity used is implemented, it is necessary to grasp the size of each disk. Accordingly, with the file system 1, the value of the total size of files within a directory is assigned to the directory including the files as one piece of attribute data as shown in FIG. 10.

This capability is prepared, so that it becomes possible to obtain the total data size of files moving from one disk to another, for example, by a rename system call, by searching for only a directory, leading to the elimination of the overhead of accesses to the metadata of the files.

Specifically, this capability is implemented as follows: (a) the attribute data (the value of the total size of files, etc.) of a parent directory is searched in metadata by using the name of a target file and the i node number of its parent directory, when an open command is issued; (b) the attribute data (the file size, the date and time when a change is made, etc.) of the target file is updated; (c) and at the same time, the value of the total size of files managed as one piece of the attribute data of the parent directory is updated.

Various file operations are performed for a file system. When these operations are performed, a state violating assigned policy data can possibly occur.

If such a policy violation occurs, the file system 1 registers the occurrence of the policy violation to the attribute data possessed by policy data.

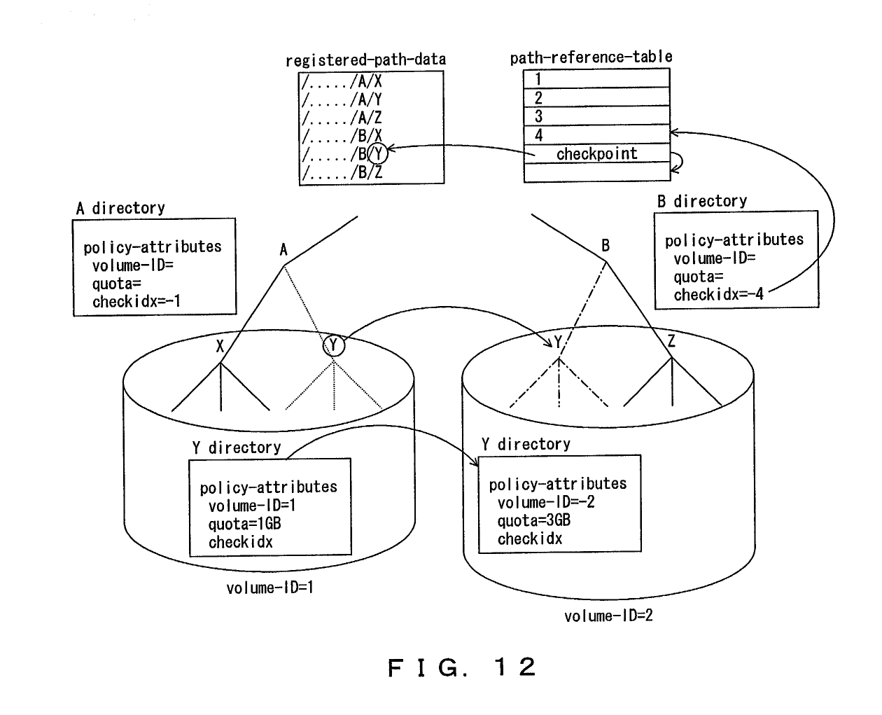

Suppose that volume allocation (volume-ID), quota, and a flag indicating whether or not to require a search (check index) are assigned as policy attributes in a file system having multiple volumes shown in FIG. 12. If a rename system call for requesting the name of a Y directory from “A/Y” to “B/Y” is issued in this case, the determination of whether or not to apply a policy to the directory B, a move of the file data within the Y directory from the volume allocation “volume-ID=1” to “volume-ID=2”, which is requested by this determination, and the calculation of the quota must be performed.

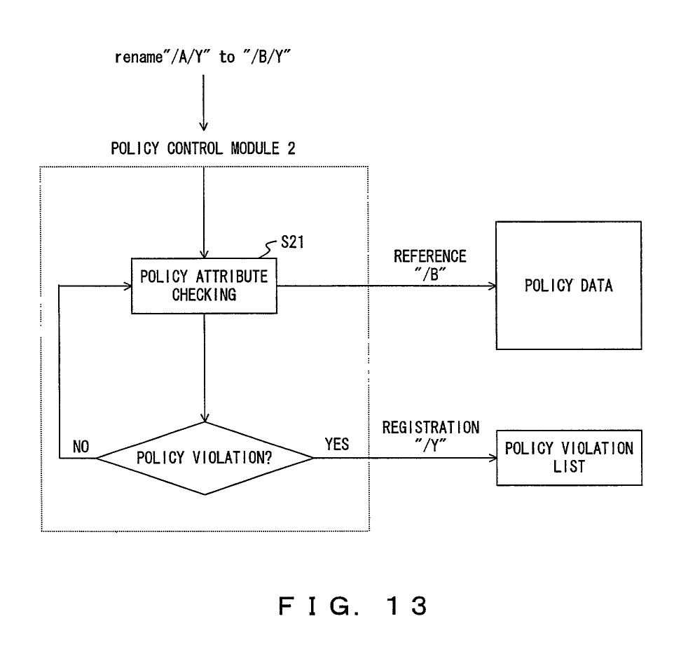

In this case, the file system 1 displays a policy violation by registering a negative value “volume-ID=−2” without moving the file data within the Y directory, as represented by the process flow shown in FIG. 13.

As a result, with the file system 1, only the following overhead is required for the rename process.

Namely, (1) it can be immediately determined whether or not to apply the policy of the directory B to the path name, that is, the Y directory after being renamed based on the index number of the path search table 5; (2) The negative value “volume-ID=2” can be easily registered without moving the file data within the Y directory; and (3) the quota can be easily calculated by making only a directory search without searching the metadata of the files within the Y directory.

Accordingly, with the file system 1, the overhead of the rename process can be significantly reduced.

The rename process is further explained in detail below. When the rename command is issued, the file system 1 searches metadata for the attribute data of a parent directory by using the name of a target file and the i node number of the parent directory. If policy data exists in the attributes of the searched target file, or if policy data (including the flag indicating whether or not require a path search) exists in the attributes of the directory B at the move destination, the process is transferred to the policy control module 2.

When invoked in this way, the policy control module 2 checks the attribute data of the target file and the directory at the move destination (step S21 of FIG. 13). Since the path search flag (−4: a negative value) is set for the directory B in the example shown in FIG. 12, the path search process is performed. The index in the path search table 5, which is indicated by the path search flag, does not include target path search data in the example shown in FIG. 12. Therefore, the target path search data is obtained by searching the path search table 5.

Then, a comparison with the path name specified by the registered policy according to the checkpoint within the path search table 5 is made. As a result of this comparison, the path name “/B/Y” specified by the registered policy is proved to assign the volume “volume-ID=2” in the example shown in FIG. 12. Since the data within the directory Y exists in “volume-ID=1” in the example shown in FIG. 12, this violates the policy. Therefore, the i node number of the directory Y, a violation capability ID, etc. are registered to the policy violation list shown in FIG. 13.

By adopting such a configuration for registering a policy violation, the overhead of the policy implementation process can be eliminated, and at the same time, a write error is prevented from occurring, whereby the specifications of a general-purpose UNIX file system can be conformed regardless of whether or not a policy exists.

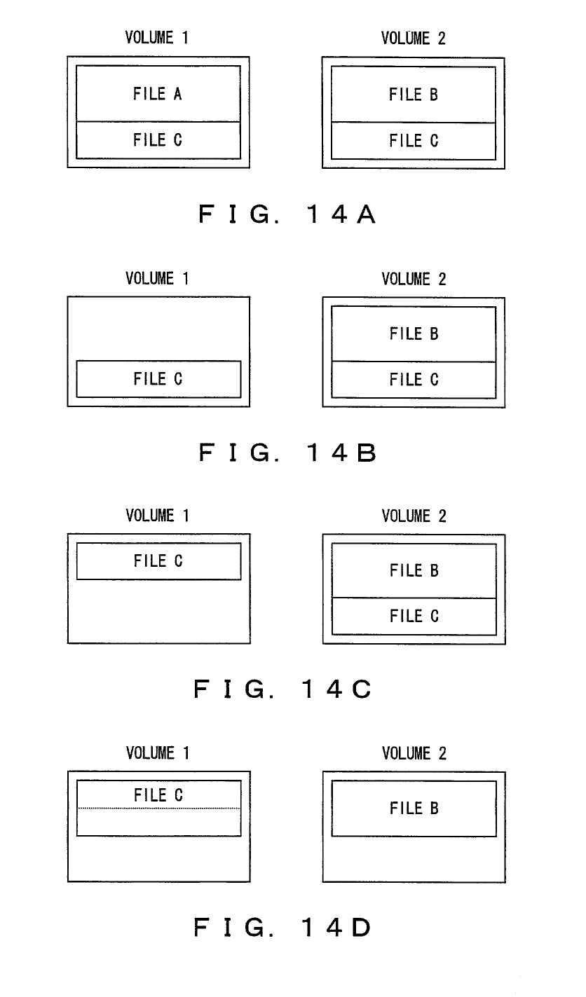

A policy violation recovery capability comprised by the file system 1 is explained last with reference to FIG. 14.

FIG. 14A assumes that a file A is assigned to a volume 1 as specified by a policy, and also a file B is assigned to a volume 2 as specified by a policy, but a file C, which should be assigned to the volume 1 as specified by a policy, cannot be included only in the volume 1 and assigned also to the volume 2. Namely, the file C is in the state of policy violation.

Further assume that the file A is erased (moved) in this state, as shown in FIG. 14B. The policy recovery capability prepared by the file system 1 immediately searches for the file C the policy of which is to be recovered by searching the policy violation list, to which the file C is registered as policy-violation, for a file/directory the policy of which is to be recovered, and determines whether or not the policy of the searched file C can be recovered according to the state of the system such as an empty space of a volume, etc.

Since the file A is erased (moved) in the example shown in FIG. 14B, it is determined that the policy of the file C can be recovered.

If it is determined that the policy can be recovered, the policy recovery capability prepared by the file system 1 performs a process for recovering the policy while optimizing the searched file/directory the policy of which is to be recovered.

This process is explained with reference to the example shown in FIG. 14. The policy violation of the file C is recovered by moving the data of the file C stored on the volume 2 to the volume 1 after moving the data of the file C stored on the volume 1, so that the data of the file C stored on the volume 2 is located on the volume 1 in an optimum form (a continuous form in this case), as shown in FIG. 14C. At this time, the policy violation registration of the file C is deleted from the policy violation list.

By preparing the capability of such a policy violation recovery process as described above, the file system 1 can not only comply with a policy, but also optimize data access performance.

Explained next is the case where a program implementing the above described file system is stored on a portable storage medium such as a CD-ROM, a floppy disk, etc., or a storage device possessed by a program provider, and executed by being loaded into a user computer.

If the file management program is stored on a portable storage medium such as a CD-ROM, a floppy disk, etc., the portable storage medium is inserted in a computer drive to read the program, and the read program is stored in a storage device such as a RAM, a hard disk, etc., so that the program is executed. If the program is provided from a program provider via a communications line, the program stored in the storage device, the memory, etc. of the program provider is received by a computer via a communications line. The received program is stored in a storage device such as a RAM, a hard disk, etc., and executed. The program recorded on the portable storage medium may include part of the capabilities of the program referred to in the preferred embodiments.

As described above, with the file system according to the present invention, policy attribute data specific to a file can be provided in correspondence with the path information of a directory, thereby adding various values. Additionally, since an inheritance method is varied depending on the capability of the policy attribute data at this time, consistency of an individual policy capability can be maintained.

For example, a volume number is defined as one piece of attribute data possessed by policy data, so that a file system administrator can store a file on his or her desired disk according to the specification of a directory in which the file is to be stored.

Additionally, for example, quota is defined as one piece of the attribute data possessed by the policy data, so that the file system administrator can restrict the disk capacity used for files within a directory. As a result, the disk capacity used can be restricted for each path-name.

Furthermore, for example, an instruction to gather statistical information is defined as one piece of the attribute data possessed by the policy data, so that the file system administrator can gather the statistical information a file or a file group by targeting the file or the file group within a directory.

Still further, with the file system according to the present invention, the capability for assigning the information of the total size of files within a directory to the directory including the files as one piece of attribute data is prepared. Therefore, it becomes possible to obtain the total data size of files moving from one disk to another, for example, by a rename system call by searching for only the directory, thereby eliminating the overhead of accesses to the metadata of the files.

Still further, with the file system according to the present invention, the interface backing up and restoring policy data is prepared, so that policy data dependent on a file system can be held without changing the specifications of the data format of a conventional archive file, and at the same time, a file having policy data dependent on one file system can be restored in another file system without changing the specifications of the data format of a conventional archive file.

Still further, with the file system according to the present invention, the capability for enabling a fast search so as to determine whether or not a directory in which policy data is restored is a directory specified by policy data, when the policy data is restored the same time the file data stored in an archive file is restored, is prepared, thereby quickly restoring the policy data.

Still further, with the file system according to the present invention, the capability for registering an occurrence of a policy data violation state to corresponding attribute data possessed by policy data, if the policy data violation state occurs when a file operation is performed, is prepared, whereby a write error can be prevented from occurring, and the specifications of a general-purpose UNIX file system can be conformed regardless of whether or not a policy exists.

As described above, with the file system according to the present invention, not only the overhead of a policy implementation process, but also the overhead and errors of each interface such as a rename, etc., which occur in a multi-volume file system, are reduced, and besides, it becomes possible to implement a policy capability without changing the specifications of the data format of an archive file while realizing the compatibility with a popular UNIX file system, etc. This greatly contributes to data management with high performance and high reliability for the whole of a system.

What is claimed is:

1. A file system configured by one or a plurality of volumes, comprising:
a setting unit setting policy attribute data in correspondence with path information of a directory; and
a file managing unit managing a file based on policy data composed of the path information of the directory and the policy attribute data.

2. A file system configured by one or a plurality of volumes, comprising:
a setting unit setting policy attribute data in correspondence with path information of a directory; and
an assigning unit assigning policy attribute data of a directory so as to be inherited to a subdirectory, or assigning specified policy attribute data to a subdirectory.

3. The file system according to claim 1, wherein
information indicating whether or not to require a path search is registered in correspondence with the policy attribute data.

4. The file system according to claim 3, further comprising
a control table storing information indicating a directory to be searched next, wherein
pointer information pointing to a storage location within said control table is registered as policy attribute data of a directory.

5. The file system according to claim 4, wherein
checkpoint information indicating path information of a directory yet to be generated is registered to said control table for the directory.

6. The file system according to claim 4, wherein
checkpoint information registered to said control table is searched, and a directory for which the checkpoint information is set is searched.

7. The file system according to claim 2, wherein
when a name of a directory is changed, policy attribute data of a parent directory is inherited to a subdirectory if policy attribute data is not specified for the subdirectory, and specified policy attribute data is assigned to a subdirectory if the policy attribute data is specified for the subdirectory.

8. The file system according to claim 2, wherein:
whether or not to require inheritance is predefined for the policy attribute data; and
policy attribute data of a parent directory is assigned so as to be inherited to a subdirectory if the policy attribute data of the parent directory is data which is requested to be inherited, or specified policy attribute data is assigned to the subdirectory if the policy attribute data of the parent directory is data which is not requested to be inherited.

9. The file system according to claim 1, further comprising
a policy violation registering unit registering policy violation information indicating a policy attribute violation to corresponding policy attribute data, if a file operation which violates the policy attribute data is performed.

10. The file system according to claim 1, further comprising
a policy recovering unit causing a file or a directory which violates a policy to comply with the policy, and deleting corresponding policy violation information.

11. The file system according to claim 1, wherein
information of a total size of files within a directory is registered as policy attribute data of the directory.

12. The file system according to claim 1, wherein
when a file is stored in an archive file, policy data composed of path information of a directory and policy attribute data is stored in the archive file.

13. The file system according to claim 12, further comprising
a registering unit reading and registering the policy data stored as a hidden file in the archive file, when the file is backed up.

14. The file system according to claim 13, wherein
when a file is restored, a comparison is made between path information of a directory to be generated and path information of a directory within the policy data stored as the hidden file in the archive file, and the policy attribute data is set for the directory the path information of which matches.

15. A file management method for use in a file system configured by one or a plurality of volumes, comprising:
setting policy attribute data in correspondence with path information of a directory; and
managing a file based on policy data composed of the path information of the directory and the policy attribute data.

16. A computer-readable storage medium on which is recorded a program for causing a computer to execute a process, said process comprising:
setting policy attribute data in correspondence with path information of a directory; and
managing a file based on policy data composed of the path information of the directory and the policy attribute data.

17. A computer-readable storage medium on which is recorded a program for causing a computer to execute a process, said process comprising:
setting policy attribute data in correspondence with path information of a directory; and
assigning policy attribute data set for a directory so as to be inherited to a subdirectory, or assigning specified policy attribute data to a subdirectory.
